(19) United States
(12) Patent Application Publication
(10) Pub. No.: US 2013/0126283 A1
(43) Pub. Date: May 23, 2013

(54) Brake Shoe of a Drum Brake, Brake Shoe Set, and Drum Brake

(71) Applicant: KNORR-BERMSE Systeme fuer Nutzfahrzeuge GmbH, Muenchen (DE)

(72) Inventor: Viktor PAPP, Morahalom (HU)

(73) Assignee: KNORR-BREMSE Systeme fuer Nutzfahrzeuge GmbH, Muenchen (DE)

(21) Appl. No.: 13/682,234

(22) Filed: Nov. 20, 2012

Related U.S. Application Data
(63) Continuation of application No. PCT/EP2011/058354, filed on May 23, 2011.

(30) Foreign Application Priority Data
May 25, 2010 (DE) 10 2010 021 393.4

(51) Int. Cl. F16D 51/32; F16D 65/08

(52) U.S. Cl. CPC F16D 51/32; F16D 65/08
USPC 188/335; 188/251 R

(57) ABSTRACT

A drum brake and brake shoes of a drum brake having more than two brake shoes is provided. The brake shoes have a lining carrier plate having a support surface on which at least one circular arc-shaped brake lining located, the support surface being supported on a brake shoe web. The brake shoes have a first end pivoting on brake shoe carriers, and a free end supported by an actuating element. The web includes an extension segment between the lining carrier plate and the first end pivot. Brake shoes pairs may be arranged with a primary brake shoe having a guide on the side of the extension segment facing the brake drum for actuating a secondary shoe of the pair. Where two brake shoe pairs are present, the secondary brake shoes may overlap and have their first end pivots located with the pivots of the opposite pair's primary brake shoe.

### CROSS REFERENCE TO RELATED APPLICATIONS

This application is a continuation of PCT International Application No. PCT/E-2011/058354, filed May 23, 2011, which claims priority under 35 U.S.C. §119 from German Patent Application No. 10 2010 021 393.4, filed May 25, 2010, the entire disclosures of which are herein expressly incorporated by reference.

### BACKGROUND AND SUMMARY OF THE INVENTION

The present invention relates to a brake shoe of a drum brake having more than two brake shoes. More particularly, the present invention relates to such a brake having at least one circular arc-shaped brake lining with a return element which includes a pivotal linkage supported on a brake shoe holder and at its free end is connected via an actuating element to an actuating device of the drum brake.

Large braking forces, which serve to press the brake shoes against the circumferential surface of a brake drum, are required for the actuation of a known drum brake. A known method for reducing this necessary braking force is to use multi-piece brake shoes, in which the brake shoes are pivotally fastened to a brake shoe holder, which as pivot is held against a holder disk that is torsionally secured relative to the brake drum.

The arrangement of more than two brake shoes in one drum brake is also known, for example from German patent document no. DE 1 011 677, in which three brake shoes are suspended on a hexagonal elastic body and are each pivotally attached by respective bolts to the corner points of the elastic body and pressed against the friction surfaces of the brake drum by compression springs.

The object of the present invention is to further develop a brake shoe or a set of brake shoes and a brake drum of the respective generic type, so that during actuation a pressure distribution achieved on the friction surface of the brake drum is as uniform as possible.

According to the invention, a brake shoe comprises an extension segment of a web, which extends away from the brake lining holder plate and at the remote end of which a pivotal linkage is formed, and a guide for actuating an adjacent brake shoe is provided on the side of the extension segment facing the brake drum. A brake shoe embodied in this way can be pivoted by an actuating device, and at the same time via the guide is capable of actuating an adjacent brake shoe operatively connected to this brake shoe. Using a brake shoe embodied in this way for actuating a drum brake therefore allows a second brake shoe operatively connected to this brake shoe to be actuated simultaneously.

In a related embodiment, a brake shoe is embodied in such a way that an actuating element that can be brought into operative connection with a guide of the adjacent brake shoe is provided at the free end of the web situated opposite the pivotal linkage.

Fitting two such brake shoe sets in a drum brake makes it possible, with a relatively low pressure, to achieve a relatively high overall pressure level for actuating the drum brake. The arrangement of the brake shoes in the drum brake moreover exploits virtually the entire friction surface of the brake drum.

Due to the optimized movement characteristics of the individual brake shoes an optimum uniform pressure distribution is achieved.

Advantageous design variants of the invention form the subject matter of the dependent claims.

According to an advantageous design variant the actuating element on the respective brake shoes is embodied as a rolling element with an axis of rotation aligned parallel to the axis of symmetry of the brake drum. Such a rolling element is a simple and cost-effective way of guiding the movement of the brake shoe.

According to a further design variant the AIR ratio is between 0.6 and 0.9, where R is the radius of the friction surface of the brake lining and A is the distance between brake drum axis and the pivotal linkage of the brake shoe on the brake shoe holder. This ratio guarantees an optimum distribution of force and friction in the drum brake. The optimized distribution of force and friction also improves the maximum temperature characteristics and the duration of loading compared to drum brakes known in the state of the art. The service life of such a drum brake according to the invention is also increased by the larger total useful friction surface overall.

According to a further advantageous design variant the ratio of an angle covered by the brake lining to an angle, which extends from the end of the brake lining remote from the free end of the brake shoe to the pivotal linkage, is between 2/3 and 5, in particular between 2/3 and 5/3. These angle ratios have proved particularly advantageous for the interaction of the brake shoes and the pivotal linkage thereof.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a perspective view of a drum brake according to an embodiment of the present invention,

FIG. 2 shows a cross sectional view through a drum brake having enclosed brake shoes according to an embodiment of the present invention,

FIG. 3 shows the cross sectional view of the drum brake in FIG. 2 omitting the suspension,

FIG. 4a shows a top view of a first brake shoe according to an embodiment of the present invention,

FIG. 4b shows a top view of a first brake shoe according to another embodiment of the present invention,

FIG. 5 shows a top view of a second brake shoe according to an embodiment of the present invention,

FIG. 6a shows a top view of a brake shoe set according to an embodiment of the present invention,

FIG. 6b shows a top view of a brake shoe set according to another embodiment of the present invention.

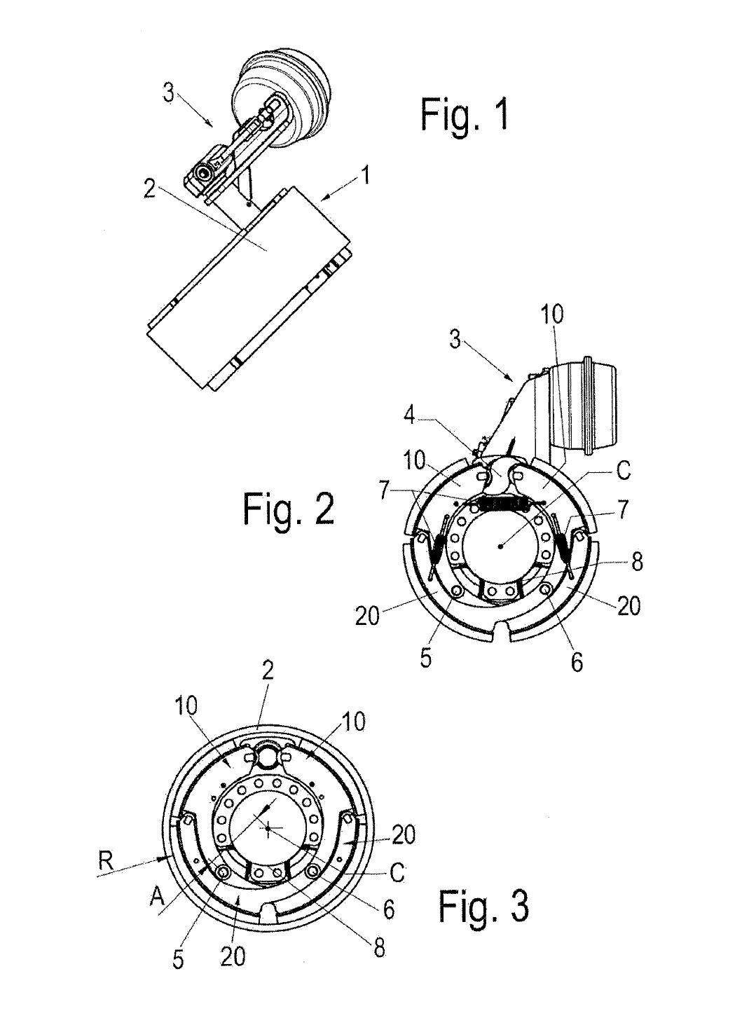

### DETAILED DESCRIPTION OF THE DRAWINGS

In the following description of the figures, terms such as top, bottom, left, right, front, rear etc. relate exclusively to the exemplary representation and position of the brake shoe, the drum brake and other parts selected in the respective figures. These terms are not to be interpreted in a restrictive sense, that is to say these references may vary due to different working positions or the mirror-symmetrical configuration or the like.

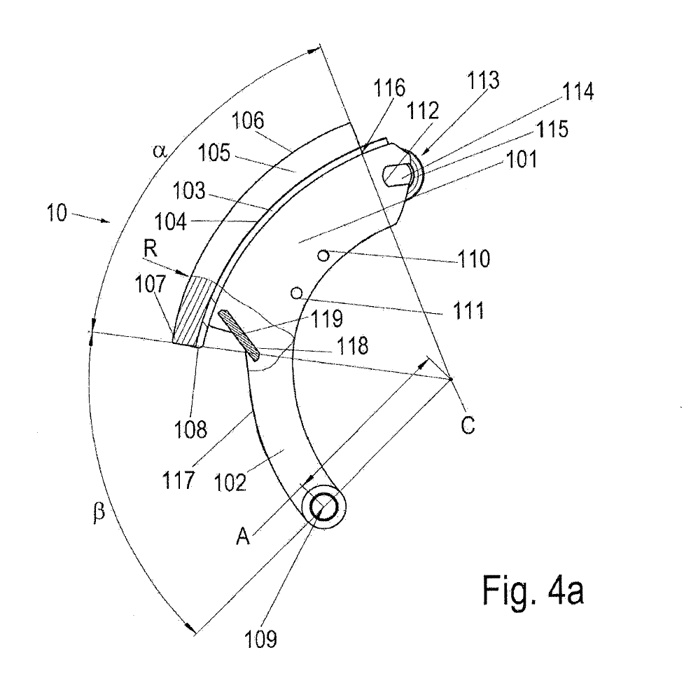

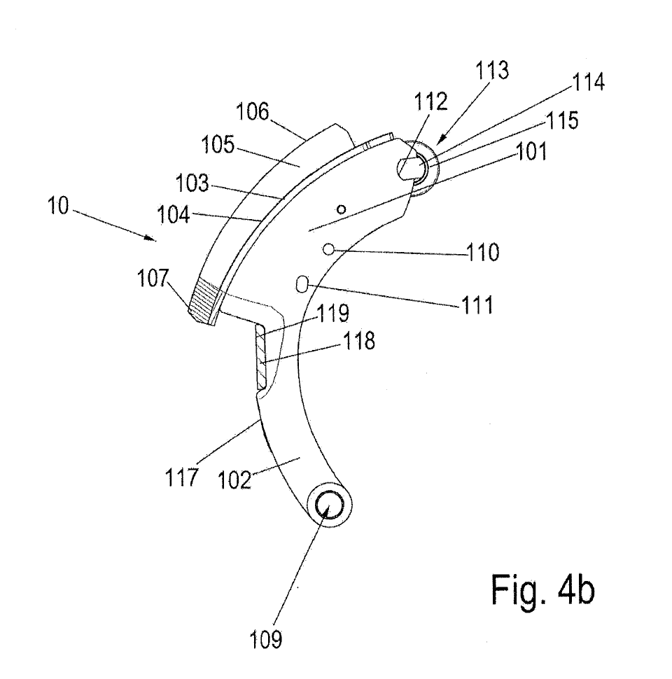

In the figure the reference numeral 1 denotes a design variant of a drum brake according to the invention overall. It comprises a brake drum 2 having enclosed brake shoes 10, 20 and an actuating device 4, which is connected to a drive arranged on a holder 3. As is shown in FIGS. 2 and 3, more than two brake shoes 10, 20, in the exemplary embodiment shown here a total of four brake shoes 10, 20, are arranged internally in the brake drum 2. Each of the brake shoes 10, 20 is pivotally supported on a brake shoe holder 5, 6, the brake shoe holder 5, 6 being immovably fastened to a holder disk 8.

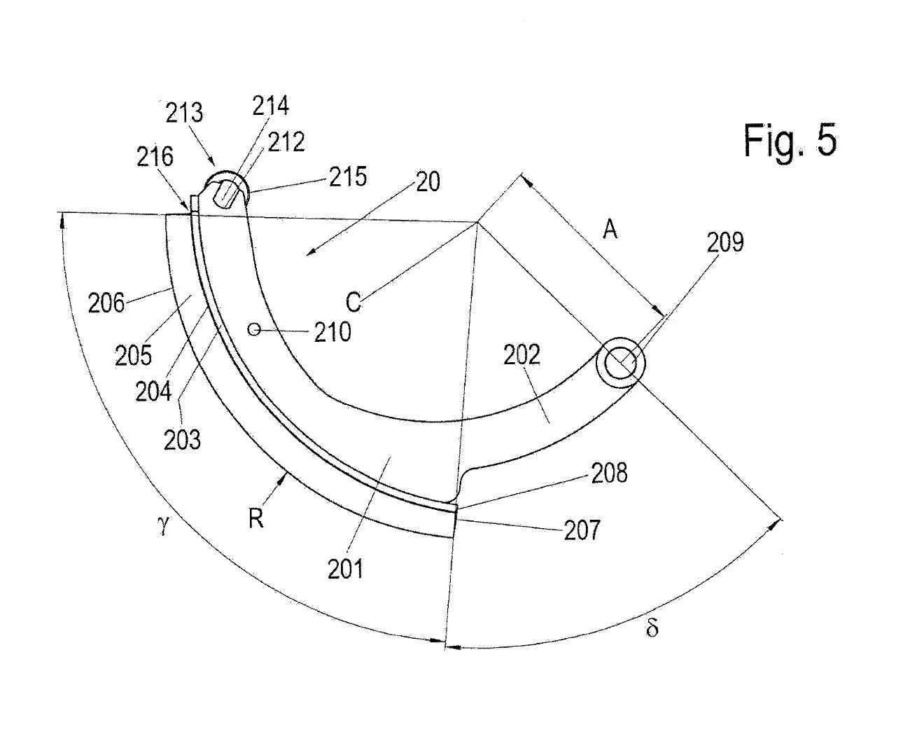

The design variant of a brake shoe 10 according to the invention shown in FIGS. 4a and 4b is provided with a brake lining holder plate 103, which comprises a support surface 104, fastened to which is a brake lining 105 having a friction surface 106 that is capable of coming into contact with the enclosed friction surface of the brake drum 2.

Here the brake lining holder plate 103 is connected, for example by welding, to a web 101, one end 116 of which is operatively connected via an actuating element 113 to the actuating device 4 shown in FIGS. 2 and 3, via which the braking force can be applied to the brake shoe 10.

The actuating element 113 here is preferably embodied as a rolling element 115 having an axis of rotation aligned parallel to the axis of symmetry of the brake drum 2, the rolling element 115 preferably being suspended via a pin 114, which is locked in a groove 112 in the end face of the web 101 facing the actuating device 4.

At its other end the web 101 is extended by an extension segment 102, which extends away from the brake lining holder plate 103 and formed on the remote end of which is a pivotal linkage 109, preferably embodied as a bore for a brake shoe holder 5, 6 embodied as a fastening pin, via which pivotal linkage the brake shoe 10 is pivotally connected to the immovably fixed holder disk 8.

On the side 117 of the extension segment 102 facing the brake drum 2 a guide, which as shown here is preferably embodied as a guide element 118 inserted into the side 117 of the extension segment 102 facing the brake drum 2, is provided for actuating an adjacent brake shoe 20. Here, according to a variant shown in FIG. 4a, the guide element 118 is plane and preferably let into the web at an angle to the side 117 of the extension segment 102 and of the brake lining holder plate 103 facing the brake drum 2, one end of the guide element 118 projecting into the area of the web 101 close to the brake lining holder plate 103 and the other end projecting into the extension segment 102. Here the transitions between the exposed segment of the guide element 118 and the side 117 of the extension segment 102 facing the brake drum 2 or the area of the web 101 close to the brake lining holder plate 103 are of obtuse-angled design, preferably in an angle range from approximately 130° to 160°.

Alternatively, according to a variant shown in FIG. 4b, the guide element 118 may be plane or it may be let into the side 117 of the extension segment 102 facing the brake drum 2 with a slight arch following the contour of the side 117 of the extension segment 2 facing the brake drum 2.

In another alternative design variant the guide may also be embodied as a guideway formed on the side 117 of the extension segment 102 facing the brake drum 2.

Operatively connected to this guide of the brake shoe 10 is an actuating element 213 of the brake shoe 20, as is shown in FIGS. 2, 3, 6a and 6b. The brake shoe 20 is likewise embodied with a brake lining holder plate 203, which is fastened to a web 201 and which comprises a support surface 204, to which at least one circular arc-shaped brake lining 205 is fastened. At the end of the brake shoe 20 facing the adjacent brake shoe 10 the actuating element 213 that can be brought into operative connection with the guide of the adjacent brake shoe 10 is provided on the web 201, so that an actuation of the first brake shoe 10 triggered by the actuating device 4 is initiated a simultaneous movement of the brake shoe 20 via the actuating element 213 and the guide on the extension segment 102 of the brake shoe 10. Like the actuating element 113 of the first brake shoe 10, the actuating element 213 here is preferably embodied as a rolling element 215 having an axis of rotation aligned parallel to the axis of symmetry of the brake drum 2, the rolling element 215 preferably being suspended via a pin 214, which is locked in a groove 212 in the end face of the web 201 facing the guide of the brake shoe 10.

An extension segment 202, which extends away from the brake lining holder plate 203 and formed at the remote end of which is a pivotal linkage 209, which is formed in the same way as the pivotal linkage of the brake shoe 10, is provided on the end of the web 201 remote from the actuating element 213. A first bore 110, which serves for the mounting of a first return element 7, which serves for coupling together the brake shoes 10 operatively connected to the actuating device 4, is provided on the web 101. Following a braking sequence, in which the two brake shoes 10 have been moved apart from their rest position into a braking position by the actuating device 4, the return element 7, preferably embodied as a tension spring, pulls the two brake shoes 10 back into their initial position as the actuating device 4 is run back into its initial position by the tensile force of the return element 7.

Also provided on the web 101 is a second bore 111, which serves for the mounting of a second return element 7, which serves for coupling together the brake shoe 10 operatively connected to the actuating device 4, and the adjacent brake shoe 20 that can be actuated via the guide of this brake shoe 10. Here the second mounting point of this return element 7 is a bore 210 in the web 201 of the second brake shoe 20. Following a braking sequence the return element 7, preferably likewise embodied as a tension spring, serves to move the second brake shoe 20 back into its initial position due to the movement of the brake shoe 10, operatively connected to the actuating device 4, back into its initial position, likewise under the tensile force of the return element 7.

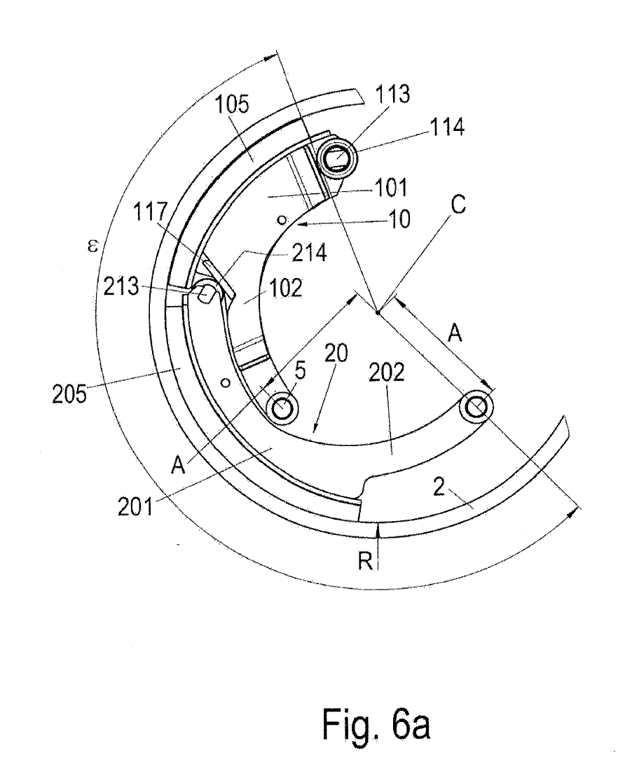

As can be seen from FIGS. 4a and 5, the radius R of the friction surface 106, 206 of the respective brake lining 105, 205 of the brake shoes 10, 20 and the distance A between a brake drum axis C and the pivot point 109, 209 of the brake shoes 10, 20 on the brake shoe holder 5, 6 is designed so that the A/R ratio is between 0.6 and 0.9. According to a particular design variant this A/R ratio is between 0.6 and 0.7.

The size ratios of the webs 101, 201 with the brake lining holder plate 103, 203 fastened thereto and the brake lining 105, 205 and the extension segment 102, 202 of the respective brake shoes 10, 20 are designed so that, viewed from the brake drum axis C, the ratio of an angle α, γ covered by the brake lining 105, 205 to an angle β, δ, which extends from the end of the brake lining 105, 205 remote from the free end 116, 216 of the respective brake shoe 10, 20 to the pivotal linkage 109, 209, is between 2/3 and 5. According to a particular design variant this ratio of the angle α, γ to the angle β, δ is between 2/3 and 5/3.

The sum of the angles α, β, of the brake shoe 10 and of the angles γ, δ of the brake shoe 20 is preferably between 110° and 180°. According to an especially preferred design variant the sum of the angles is between 110° and 130°.

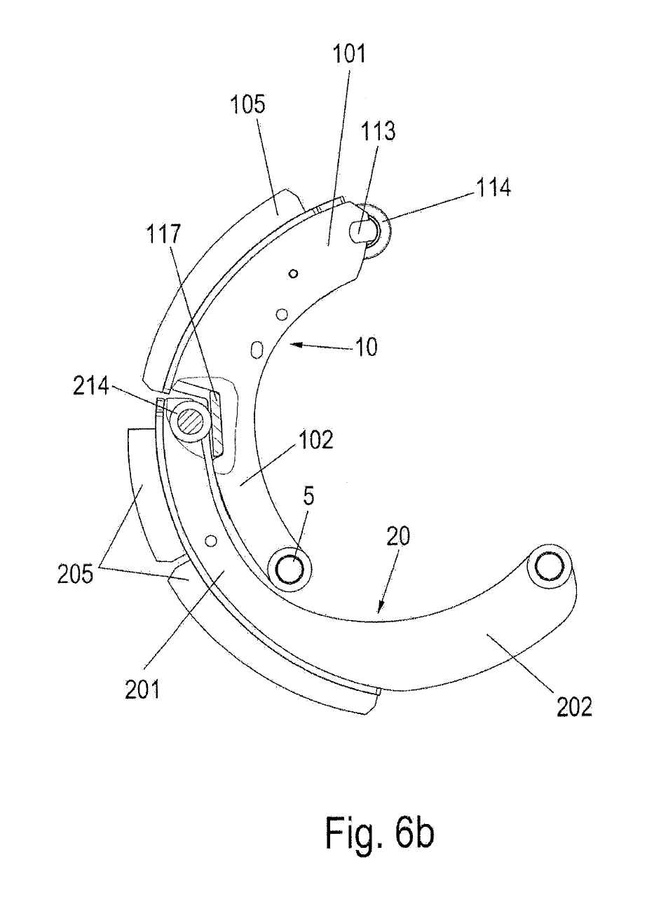

As can be seen particularly clearly from FIG. 6a, in the case of the brake shoe set depicted here, comprising a primary brake shoe 10, which is operatively connected to the actuating device, and a secondary brake shoe 20, which can be deflected via the primary brake shoe 10, an angle ε between the free end 116 of the primary brake shoe 10 and the pivotal linkage 5, 6 of the secondary brake shoe 20 operatively connected to the primary brake shoe 10 is more than 180°.

In the drum brake according to the invention, which preferably comprises two brake shoe sets each having a primary brake shoe 10 and a secondary brake shoe 20, all brake shoes can be actuated by the one in the actuating device 4, as can be clearly seen from FIGS. 2 and 3. It is also feasible for a secondary brake shoe 20 to be coupled solely to one of the primary brake shoes 10.

The extension segments 102, 202 of the two secondary brake shoes 20 are arranged crosswise. Preferably one primary brake shoe 10 and one a secondary brake shoe 20 is supported on each of the brake shoe holders 5, 6 via the respective pivotal linkage 109, 209.

The actuating device 4 is preferably embodied as a cam or camshaft. Also feasible, however, are any other embodiments of the actuating device 4 in the form of a brake block or working cylinder. Embodiments in the form of electrical or electromechanical devices having a transmission element, for example, as actuating device 4 are also feasible.

Besides the design variant of the actuating element 113, 213 in the form of a rolling element 115, 215, the actuating element may also be embodied as an interchangeably fitted gap-compensating element. Furthermore, a linkage plate may additionally be incorporated in the actuating element 113, 213.

The foregoing disclosure has been set forth merely to illustrate the invention and is not intended to be limiting. The arrangement and the pivotal linage of the brake shoes in the drum brake according to the invention allow a synchronous movement and afford a large friction surface, which owing to the uniform pressure distribution ensure a long service life of the drum brake. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 drum brake

2 brake drum

3 holder

4 actuating device

5 brake shoe holder

6 brake shoe holder

7 return element

8 holder disk

10 brake shoe(s)

20 brake shoe(s)

101 web

102 extension segment

103 brake lining holder plate

104 support surface

105 brake lining

106 friction surface

109 pivotal linkage/pivot point

111 bore

112 groove

113 actuating element

114 pin

115 rolling element

116 end

117 side

118 guide element

201 web

202 extension segment

203 brake lining holder plate

204 support surface

205 brake lining

206 friction surface

209 pivotal linkage/pivot point

210 bore

213 actuating element

214 pin

215 rolling element

216 end

A distance

C brake drum axis

R radius

α angle

β angle

γ angle

δ angle

ε angle

What is claimed is:

1. A brake shoe of a drum brake having more than two brake shoes arranged in a brake drum, the drum brake having a brake lining holder plate which is fastened to the brake shoe, the brake shoe comprising:
at least one circular arc-shaped brake lining;
a brake lining holder plate comprising a support surface to which the at least one brake lining is coupled;
a brake shoe web supporting the brake lining;
a pivot at a first end of the brake shoe configured to be pivotally supported on a brake shoe holder of the drum brake;
an actuation device receiving feature at a second free end of the brake shoe opposite the first end configured to be supported by an actuating element on an actuating device of the drum brake; and
a guide for actuating an adjacent brake shoe provided on a side facing the brake drum of an extension segment of the brake shoe web which extends between a pivot end of the brake lining holder plate and the pivot at the first end.

2. The brake shoe as claimed in claim 1, wherein
the guide is a guideway formed on the side of the extension segment facing the brake drum.

3. The brake shoe (10) as claimed in claim 1, wherein
the guide is a guide element inserted into the side of the extension segment facing the brake drum.

4. The brake shoe as claimed in claim 1, wherein
a first bore for mounting a first return element for coupling together brake shoes operatively connected to the actuating device is provided on the web, and
a second bore for mounting of a second return element for coupling together the brake shoe operatively connected to the actuating device and the adjacent brake shoe.

5. A brake shoe of a drum brake having more than two brake shoes arranged in a brake drum, the drum brake having a brake lining holder plate which is fastened to the brake shoe, the brake shoe comprising:
at least one circular arc-shaped brake lining;
a brake lining holder plate comprising a support surface to which the at least one brake lining is coupled;
a brake shoe web supporting the brake lining;
a pivot at a first end of the brake shoe configured to be pivotally supported on a brake shoe holder of the drum brake; and
an actuation device receiving feature at a second free end of the brake shoe opposite the first end configured to be supported by an actuating element on a guide of an adjacent brake shoe,
wherein the brake shoe web comprises an extension segment extending between the brake lining holder plate and at the pivot at the first end.

6. The brake shoe as claimed in claim 1, wherein the actuating element is a rolling element having an axis of rotation aligned parallel to the axis of symmetry of the brake drum.

7. The brake shoe as claimed in claim 5, wherein the actuating element is a rolling element having an axis of rotation aligned parallel to the axis of symmetry of the brake drum.

8. The brake shoe as claimed in claim 1, wherein a ratio between a distance A between a brake drum center axis C and the pivot at the first end of the brake shoe when the brake shoe is pivotally supported on a brake shoe holder of the brake drum and a radius R of a friction surface of the brake lining (the A/R ratio) is between 0.6 and 0.9.

9. The brake shoe as claimed in claim 5, wherein a ratio between a distance A between a brake drum center axis C and the pivot at the first end of the brake shoe when the brake shoe is pivotally supported on a brake shoe holder of the brake drum and a radius R of a friction surface of the brake lining (the A/R ratio) is between 0.6 and 0.9.

10. The brake shoe as claimed in claim 8, wherein an angle ratio of an angle centered on the brake drum center axis C subtended by the brake lining to an angle which extends from the pivot end of the brake lining to the pivot of the first end of the brake shoe is between 2/3 and 5.

11. The brake shoe as claimed in claim 9, wherein
an angle ratio of an angle centered on the brake drum center axis C subtended by the brake lining to an angle which extends from the pivot end of the brake lining to the pivot of the first end of the brake shoe is between 2/3 and 5.

12. The brake shoe as claimed in claim 10, wherein
the angle ratio is between 2/3 and 5/3.

13. The brake shoe as claimed in claim 11, wherein
the angle ratio is between 2/3 and 5/3.

14. The brake shoe as claimed in claim 10, wherein
a sum of the angle subtended by the brake lining and the angle which extends from the pivot end of the brake lining to the pivot of the first end of the brake shoe is 110° to 180°.

15. The brake shoe as claimed in claim 11, wherein
a sum of the angle subtended by the brake lining and the angle which extends from the pivot end of the brake lining to the pivot of the first end of the brake shoe is 110° to 180°.

16. The brake shoe as claimed in claim 1, wherein
the pivot at the first end of the brake shoe is a bore configured to receive a brake shoe holder configured as a fastening pin.

17. The brake shoe as claimed in claim 5, wherein
the pivot at the first end of the brake shoe is a bore configured to receive a brake shoe holder configured as a fastening pin.

18. A brake shoe set of a drum brake, comprising:
at least four brake shoes arranged in pairs,
wherein
a primary brake shoe of each pair of brake shoes comprises at least one circular arc-shaped first brake lining;
a first brake lining holder plate comprising a support surface to which the at least one brake lining is coupled;
a first brake shoe web supporting the first brake lining;
a first pivot at a first end of the primary brake shoe configured to be pivotally supported on a first brake shoe holder of the drum brake;
a first actuation device receiving feature at a second free end of the first brake shoe opposite the first end configured to be supported by a first actuating element on an actuating device of the drum brake; and
a guide for actuating a secondary brake shoe provided on a side facing the brake drum of a first extension segment of the first brake shoe web which extends between a pivot end of the first brake lining holder plate and the first pivot at the first end, and
the secondary brake shoe of each pair of brake shoes comprises
at least one circular arc-shaped second brake lining;
a second brake lining holder plate comprising a support surface to which the at least one second brake lining is coupled;
a second brake shoe web supporting the second brake lining;
a second pivot at a first end of the second brake shoe configured to be pivotally supported on a second brake shoe holder of the drum brake; and
a second actuation device receiving feature at a second free end of the second brake shoe opposite the first end configured to be supported by a second actuating element on a guide of the primary brake shoe,
wherein the second brake shoe web comprises a second extension segment extending between the second brake lining holder plate and at the second pivot at the first end, and
when installed in the drum brake the guide on the first extension segment of the primary brake shoe operatively supports the second actuating element of the secondary brake shoe.

19. The brake shoe set as claimed in claim 18, wherein
an angle between the free end of the primary brake shoe of each pair of brake shoes and the pivot at the first end of the secondary brake shoe of the pair of brake shoes is more than 180°.

20. A drum brake, comprising:
a cylindrical brake drum;
at least two brake shoe pairs arranged inside the cylindrical brake drum, wherein
a primary brake shoe of each pair of brake shoes comprises at least one circular arc-shaped first brake lining;
a first brake lining holder plate comprising a support surface to which the at least one brake lining is coupled;
a first brake shoe web supporting the first brake lining;
a first pivot at a first end of the primary brake shoe configured to be pivotally supported on a first brake shoe holder of the drum brake;
a first actuation device receiving feature at a second free end of the first brake shoe opposite the first end configured to be supported by a first actuating element on an actuating device of the drum brake; and
a guide for actuating a secondary brake shoe provided on a side facing the brake drum of a first extension segment of the first brake shoe web which extends between a pivot end of the first brake lining holder plate and the first pivot at the first end, and
the secondary brake shoe of each pair of brake shoes comprises at least one circular arc-shaped second brake lining;
a second brake lining holder plate comprising a support surface to which the at least one second brake lining is coupled;
a second brake shoe web supporting the second brake lining;
a second pivot at a first end of the second brake shoe configured to be pivotally supported on a second brake shoe holder of the drum brake; and
a second actuation device receiving feature at a second free end of the second brake shoe opposite the first end configured to be supported by a second actuating element on a guide of the primary brake shoe,
wherein the second brake shoe web comprises a second extension segment extending between the second brake lining holder plate and at the second pivot at the first end;
a holder disk torsionally secured in relation to the brake drum; and
each brake shoe holder is fixed to the holder disk and is configured to pivotally receive a first pivot at the first end of the primary shoe of one of the at least two pairs of brake shoes and the second pivot at the first end of the secondary brake shoe of another one of the at least two pairs of brake shoes,
wherein the second ends of the primary brake shoes of each pair of the at least two pairs of brake shoes is supported on an actuating device.

21. The drum brake as claimed in claim 20, wherein
the at least two pairs of brake shoes is configured to be actuated by the actuating device, when the primary brake shoe of each of the two pairs of brake shoes is actuated by the actuating device.

22. The drum brake as claimed in claim 21, wherein
the extension segments of the secondary brake shoes of the at least two pairs of brake shoes overlap one another when installed in the drum brake.
